(19) United States
(12) Patent Application Publication
(10) Pub. No.: US 2026/0357758 A1
(43) Pub. Date: Nov. 12, 2026

(54) Internal Combustion System with Improved Engine Brake System

(71) Applicant: DAF Trucks N.V., Eindhoven (NL)

(72) Inventor: Niek Laurentius Adrianus Hermans, Best (NL)

(21) Appl. No.: 19/673,097

(22) Filed: May 11, 2026

(30) Foreign Application Priority Data
May 12, 2025 (NL) 2040348

(51) Int. Cl. F02D 13/04; F02D 13/02

(52) U.S. Cl. CPC F02D 13/04; F02D 13/0207

(57) ABSTRACT

The internal combustion engine comprises an intake system including an intake manifold fluidly connected to the intake valves of a plurality of cylinders for supplying intake air, and an exhaust system including an exhaust manifold fluidly connected to the exhaust valves of the plurality of cylinders for expelling exhaust gases. The engine is equipped with an engine brake system operable to generate negative torque by adjusting the timing of at least one of the intake valves and the exhaust valves of the plurality of cylinders. The engine brake system comprises a control unit configured to reduce a duration of a phase wherein the intake valve is open to lower a dynamic compression ratio in a fraction of said plurality of cylinders during engine braking. By lowering the dynamic compression ratio in the selected fraction of cylinders, the enthalpy of the exhaust gases is increased relative to a given engine brake power output.

### FIELD OF INVENTION

The present invention relates to an internal combustion engine comprising a plurality of cylinders, each having a reciprocating piston subject to an intake stroke, a compression stroke, an ignition stroke, and an exhaust stroke. Each of the cylinders is provided with at least one intake valve and at least one exhaust valve. The engine further comprises an intake system including an intake manifold fluidly connected to the intake valves of the plurality of cylinders for supplying intake air, and an exhaust system including an exhaust manifold fluidly connected to the exhaust valves of the plurality of cylinders for expelling exhaust gases. The invention is particularly directed to an engine brake system operable to generate negative torque by adjusting the timing of at least one of the intake valves and the exhaust valves of the plurality of cylinders.

### BACKGROUND OF THE INVENTION

With engine braking systems, negative power is generated by increasing scavenging losses. These scavenging losses are largely influenced by the pressure upstream of the turbine, which can be regulated by components in the exhaust system, such as a variable turbine geometry mechanism, a backpressure valve, or an exhaust gas recirculation valve. Such a system is e.g. known from US20150144097.

In systems where the exhaust valve lift can be manipulated—for example, using a hydraulic actuator—the braking mechanism may operate by opening the exhaust valves near the top of the compression stroke. This allows compressed air to be released through the exhaust system. During such operation, vehicle energy is used to compress the air in the cylinders, but only minimal energy is returned to the piston during the expansion stroke. As the cycle repeats, the energy of the vehicle is dissipated, resulting in deceleration.

Engines equipped with such braking systems may regulate braking power by adjusting the exhaust system pressure. This regulation is generally accurate, relatively fast, and allows for high exhaust mass flow. To further reduce braking power, it is possible to switch off the braking function in individual cylinders. Cylinders with a deactivated braking function continue to generate internal pumping losses but contribute less to scavenging losses. The lowest braking power can be achieved by switching off all such units and closing off the exhaust path from the engine, resulting in compression of the exhaust gases within the exhaust manifold and inside the cylinder—an approach sometimes referred to as non-release braking. However, switching off the braking function in some or all cylinders may result in significantly reduced exhaust gas temperatures. This reduction in thermal energy can impair the functionality of downstream exhaust aftertreatment systems, which rely on a minimum temperature threshold to operate efficiently. For example, catalytic conversion processes, particulate oxidation, or ammonia-based nitrogen oxide reduction may be less effective at low exhaust temperatures, particularly during prolonged braking events such as long downhill descents. As a result, emissions performance can deteriorate, and component degradation or undesired deposits may occur over time. Efforts have been made in the prior art to manage engine braking performance by modifying valve timing strategies to increase exhaust gas temperature. For example, U.S. Pat. No. 10,669,951 B2 describes a four-stroke internal combustion engine in which the exhaust valve timing is phase-shifted such that the exhaust valve opens during the expansion stroke and closes during the exhaust stroke.

In systems where the exhaust valve lift can be manipulated—for example, using a hydraulic actuator—the braking mechanism may operate by opening the exhaust valves near the top of the compression stroke. This allows compressed air to be released through the exhaust system. During such operation, vehicle energy is used to compress the air in the cylinders, but only minimal energy is returned to the piston during the expansion stroke. As the cycle repeats, the energy of the vehicle is dissipated, resulting in deceleration. Engines equipped with such braking systems may regulate braking power by adjusting the exhaust system pressure. This regulation is generally accurate, relatively fast, and allows for high exhaust mass flow. To further reduce braking power, it is possible to switch off the braking function in individual cylinders. Cylinders with a deactivated braking function continue to generate internal pumping losses but contribute less to scavenging losses. The lowest braking power can be achieved by switching off all such units and closing off the exhaust path from the engine, resulting in compression of the exhaust gases within the exhaust manifold and inside the cylinder—an approach sometimes referred to as non-release braking. However, switching off the braking function in some or all cylinders may result in significantly reduced exhaust gas temperatures. This reduction in thermal energy can impair the functionality of downstream exhaust aftertreatment systems, which rely on a minimum temperature threshold to operate efficiently. For example, catalytic conversion processes, particulate oxidation, or ammonia-based nitrogen oxide reduction may be less effective at low exhaust temperatures, particularly during prolonged braking events such as long downhill descents. As a result, emissions performance can deteriorate, and component degradation or undesired deposits may occur over time. Efforts have been made in the prior art to manage engine braking performance by modifying valve timing strategies to increase exhaust gas temperature. For example, U.S. Pat. No. 10,669,951 B2 describes a four-stroke internal combustion engine in which the exhaust valve timing is phase-shifted such that the exhaust valve opens during the expansion stroke and closes during the exhaust stroke.

Insufficient exhaust temperature may delay system readiness upon re-acceleration, increasing transient emissions. In addition to thermal concerns, this approach may also exacerbate noise, vibration, and harshness during braking events, reducing overall drivability and passenger comfort.

### SUMMARY OF THE INVENTION

It is an object to provide an internal combustion engine comprising an engine brake system with improved timing control in order to enhanced temperature control of the exhaust gases during engine braking.

To this end an internal combustion engine is proposed according to the features of claim 1. In particular according to one aspect, the invention provides an internal combustion engine comprising a plurality of cylinders, each having a reciprocating piston subject to an intake stroke, a compression stroke, an ignition stroke, and an exhaust stroke. Each of the cylinders is provided with at least one intake valve and at least one exhaust valve.

The engine further comprises an intake system including an intake manifold fluidly connected to the intake valves of the plurality of cylinders for supplying intake air, and an exhaust system including an exhaust manifold fluidly connected to the exhaust valves of the plurality of cylinders for expelling exhaust gases.

The engine is equipped with an engine brake system operable to generate negative torque by adjusting the timing of at least one of the intake valves and the exhaust valves of the plurality of cylinders. The engine brake system comprises a control unit configured to reduce a duration of a phase wherein the intake valve is open to lower a dynamic compression ratio in a fraction of said plurality of cylinders during engine braking. By lowering the dynamic compression ratio in the selected fraction of cylinders, the enthalpy of the exhaust gases is increased relative to a given engine brake power output.

This provides an engine brake control having selective adjustment of intake valve timing or lift in a fraction of the cylinders so that the braking power can be modulated without fully deactivating the braking function across the engine. This allows engine braking to be maintained at lower braking demand levels at a designated level, additionally contributing to improved thermal energy in the exhaust gases during braking. This supports more favorable conditions for downstream components such as exhaust aftertreatment systems, which may otherwise suffer from reduced effectiveness during extended braking events. Furthermore, the ability to dynamically lower the compression ratio in a controlled subset of cylinders may help to reduce unwanted effects such as noise, vibration, and harshness that can arise when braking systems operate with abrupt transitions or when only a portion of the cylinders are contributing to braking torque. By providing a smoother and more thermally balanced braking mode, the system enhances both drivability and emissions system readiness. In one embodiment, the fraction of cylinders in which the dynamic compression ratio is lowered may include all of the plurality of cylinders, half of the plurality of cylinders, or at least two of the plurality of cylinders. This flexible implementation allows the engine to adaptively respond to different braking power demands while optimizing the operation of the engine and its auxiliary systems.

By adjusting the timing of the intake valve—either by early or late closing during the intake or compression stroke—or by adjusting the valve lift, it becomes possible to control the dynamic compression ratio, defined by the effective intake valve closing point relative to top dead center. Through this approach, the volumetric efficiency of the engine can be modified during engine braking, which directly influences the amount of air processed through the engine and the thermodynamic conditions of the exhaust gases.

Maintaining some or all cylinders active while reducing their dynamic compression ratio allows the engine to continue delivering braking torque, even at reduced demand levels, without fully deactivating cylinders. This ensures that the exhaust system continues to receive sufficient thermal energy to sustain proper aftertreatment performance. In particular, the increased enthalpy of the exhaust gases—achieved by reducing the mass of compressed air while preserving overall braking force—helps maintain exhaust temperatures favorable for emissions control systems. Moreover, by avoiding abrupt deactivation of cylinder functions, the system can reduce undesirable noise, vibration, and harshness (NVH), contributing to improved drivability and refinement during braking events. The combination of continuous cylinder activation, controlled intake dynamics, and modulated air handling enables a more balanced thermal and acoustic profile, while still achieving compliance with low engine brake demand scenarios.

In particular, by varying the intake valve closing timing, the engine can regulate the airflow and compression behavior in such a way that the enthalpy in the exhaust manifold is increased. This increase in thermal content can be achieved either while maintaining a constant brake power level or even during reduced braking power, offering a significant advantage in thermal management and brake modulation.

### BRIEF DESCRIPTION OF THE DRAWINGS

The invention will be further elucidated in the figures:

FIG. 1 schematically illustrates an engine brake arrangement according to an embodiment;

FIG. 2 schematically illustrates a conventional braking strategy to illustrate some aspects of the invention.

FIGS. 3A-H illustrate an example of early intake valve closing (EIVC) timing, in which the intake valve is closed earlier in the intake stroke to similarly influence the dynamic compression ratio and exhaust gas enthalpy.

FIGS. 4A-H illustrate an example of late intake valve closing (LIVC) timing, in which the intake valve is closed later in the compression stroke to reduce the dynamic compression ratio and control airflow through the engine during engine braking;

FIGS. 5A-D depict a different controlling strategy not part of the invention.

### DETAILED DESCRIPTION

Unless otherwise defined, all terms (including technical and scientific terms) used herein have the same meaning as commonly understood by one of ordinary skill in the art to which this disclosure belongs as read in the context of the description and drawings. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some instances, detailed descriptions of well-known devices and methods may be omitted so as not to obscure the description of the present systems and methods. Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be further understood that the terms “comprises” and/or “comprising” specify the presence of stated features but do not preclude the presence or addition of one or more other features.

While example embodiments are shown for systems and methods, also alternative ways may be envisaged by those skilled in the art having the benefit of the present disclosure for achieving a similar function and result. E.g. some components may be combined or split up into one or more alternative components. Finally, these embodiments are intended to be merely illustrative of the present system and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the scope of the present systems as set forth in the claims that follow. The specification and drawings are accordingly to be regarded in an illustrative manner and are not intended to limit the scope of the appended claims.

A control unit, in particular, a control unit of an engine braking system configured to change a duration of a phase wherein the intake valve is open to lower a dynamic compression ratio of a fraction of a plurality of cylinders during engine braking can be provided by circuitry or programming, by lookup tables or a combination thereof, by means known to the skilled person.

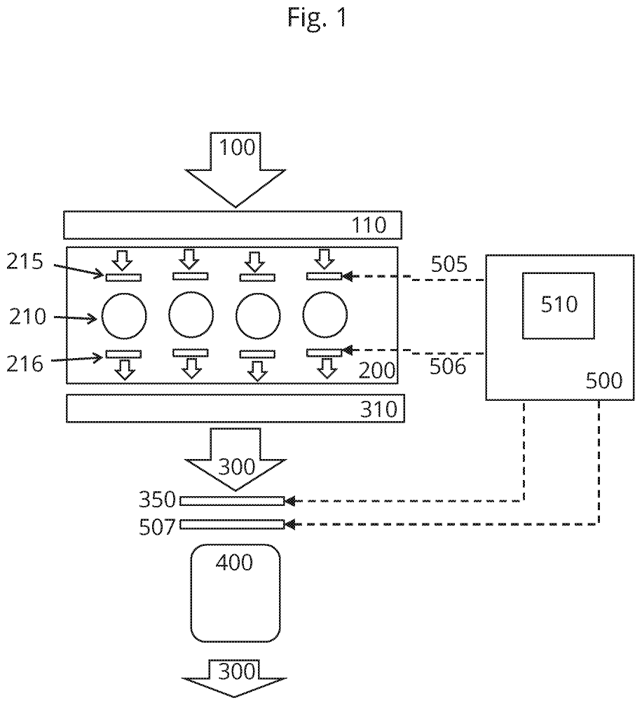

Any reference signs in the claims do not limit their scope; several “means” may be represented by the same or different item(s) or implemented structure or function; any of the disclosed devices or portions thereof may be combined together or separated into further portions unless specifically stated otherwise. The mere fact that certain measures are recited in mutually different claims does not indicate that a combination of these measures cannot be used to advantage. Now turning to FIG. 1 there is provided an internal combustion engine 200 comprising a plurality of cylinders 210, each containing a reciprocating piston configured to operate through an intake stroke, a compression stroke, an ignition stroke, and an exhaust stroke. Each cylinder 210 is equipped with at least one intake valve 215 and at least one exhaust valve 216.

An intake system 100 includes an intake manifold 110 that is fluidly connected to the intake valves 215 of cylinders 210 for supplying intake air. An exhaust system 300 includes an exhaust manifold 310 fluidly connected to the exhaust valves 216 for directing exhaust gases away from the cylinders 210.

The engine further comprises an engine brake system 500 configured to generate negative torque. The engine brake system 500 includes a valve timing actuator 505 associated with the intake valves 215. Similarly a valve timing actuator 506 is associated with exhaust valves 216 of the cylinders 210 for adjusting valve timing during engine braking. These functions may be integrated in a single device, e.g. a hydraulically actuated device. The hardware for this arrangement is known to the skilled person. A control unit 510 is configured to control the engine brake system 500 such that, during engine braking, it lowers the dynamic compression ratio in a selected fraction of the plurality of cylinders 210, for example by advancing or retarding intake valve closure. As a result, the enthalpy of the exhaust gases expelled through the exhaust 300 is increased relative to a given engine brake power output, aiding in improved thermal management and exhaust aftertreatment efficiency of an exhaust after treatment system 400. Braking power is modulated through engine braking control unit 500 and/or exhaust restriction, e.g. through a variable turbine geometry (VTG) mechanism 350 that may be utilized within the exhaust system 300 to regulate pre-turbine pressure and thus influence braking power. The VTG 350 can rapidly and accurately provide exhaust manifold pressure control while maintaining a high exhaust mass flow rate, possibly in combination with a standalone backpressure valve 507 (BPV), which may also be part of the exhaust system 300 and is controlled by engine brake system 500.

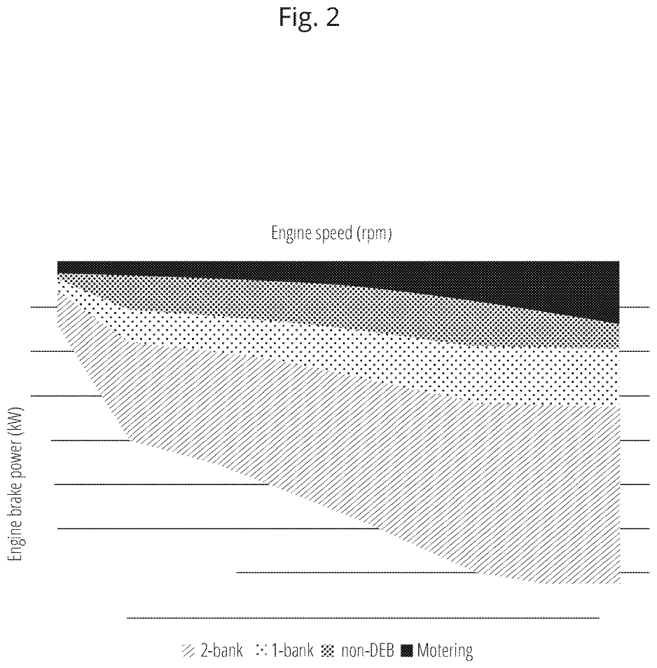

FIG. 2 illustrates an engine braking strategy applied to the internal combustion engine 200, some aspects of which are also known to the skilled person. Since the power is ‘negative’ to the vehicle propulsion the highest braking power is achieved by having all cylinders i.e. a two bank configuration braked in engine brake mode.

To reduce braking power, the engine brake system 500 may be configured to deactivate the engine brake function in a selected subset of cylinders 210, e.g. only in a single cylinder bank of three cylinders in a six cylinder engine. In cylinders where the engine brake control is deactivated, exhaust valves 216 may remain closed during the compression stroke, causing the trapped intake air to act as a spring (pumping losses), while scavenging losses are reduced due to the lack of exhaust blowdown. A low braking power mode can be achieved when the control unit 510 fully deactivates all engine brake units 505, 506 across cylinders 210 and simultaneously closes the VTG 350 and BPV 507, thereby isolating the exhaust path in exhaust 300. As a result, exhaust gases are compressed within the exhaust manifold 310 and within the cylinders 210 themselves—referred to as non-DEB braking. Additionally, motoring with no engine brake active provides a lowest brake power mode. However this motoring may come at a cost of lower enthalpy produced in the exhaust gases, leading to reduced efficiency of the catalytic conversion in system 400.

A refined engine braking strategy can be implemented by the engine brake system 500 under supervision of the control unit 510, with the objective of adjusting both brake power output and exhaust enthalpy to improve exhaust aftertreatment system 400 efficiency. To this end, during engine braking, the control unit 510 is dynamically configured to lower the compression ratio in a selected fraction of the cylinders 210. The fraction may include all, half, or at least two of the cylinders, depending on braking demand. When applied to all of the cylinders, NVH issues can be further diminished since engine braking can be applied without transitional phases where cylinder banks are activated or deactivated, while keeping the other cylinders running.

This modulation of the cylinder compression ration may be achieved through early intake valve closure during the intake stroke, late intake valve closure during the compression stroke, or by adjusting the intake valve lift.

In some modes, the control unit 510 maintains fixed intake valve opening timing or valve lift and adjusts only the closing timing to achieve compression ratio modulation. These strategies reduce compression work and increase the energy expelled as heat into the exhaust manifold 310, enhancing the enthalpy of the exhaust gases. The approach supports efficient catalyst heating of exhaust aftertreatment system 400, especially under conditions of reduced brake power demand.

Control unit 510 may also regulate the intake pressure through actuation of components in the intake system 100. In one scenario, it increases intake pressure, e.g. through VTG control, while simultaneously lowering the dynamic compression ratio. This enables the maintenance of constant engine brake power while further increasing the exhaust enthalpy. Such coordination supports both braking performance and aftertreatment thermal requirements.

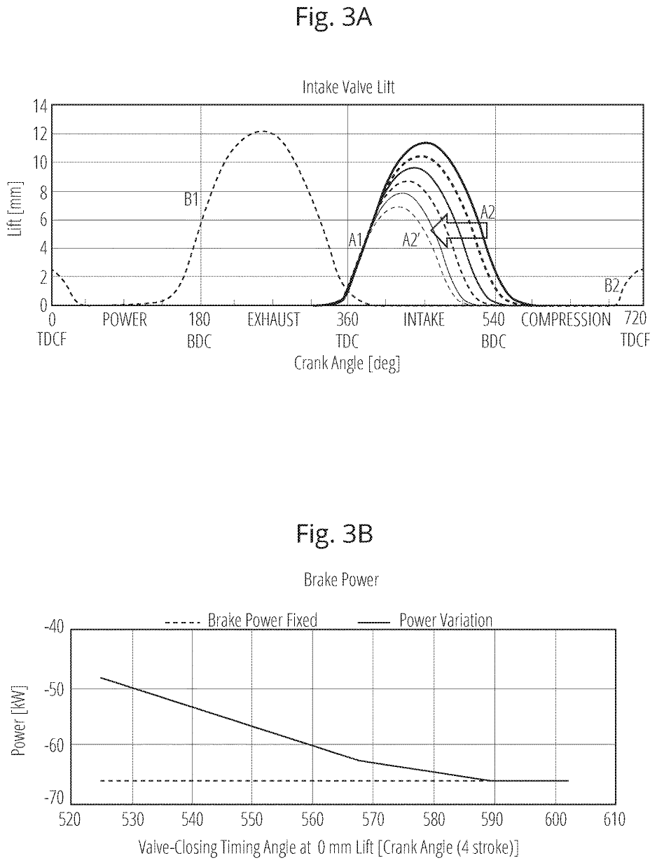

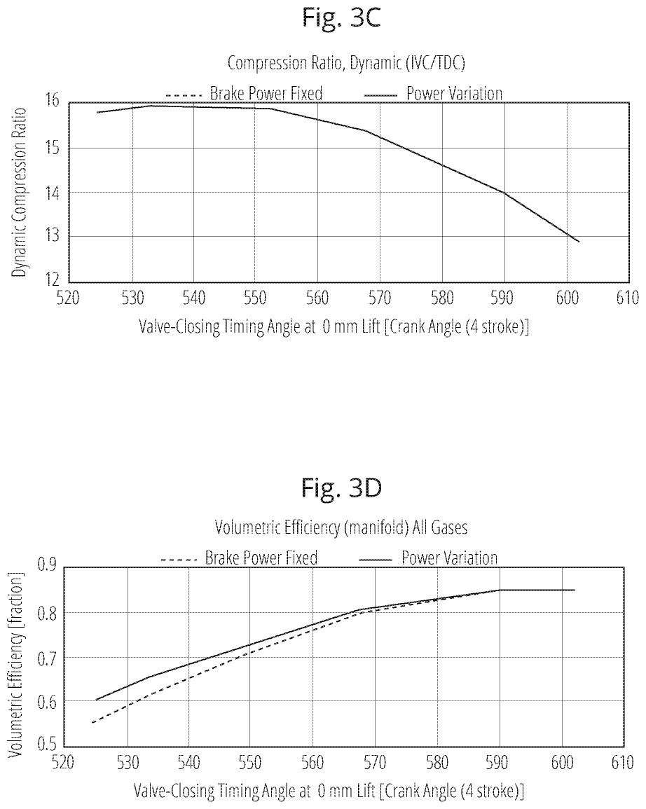

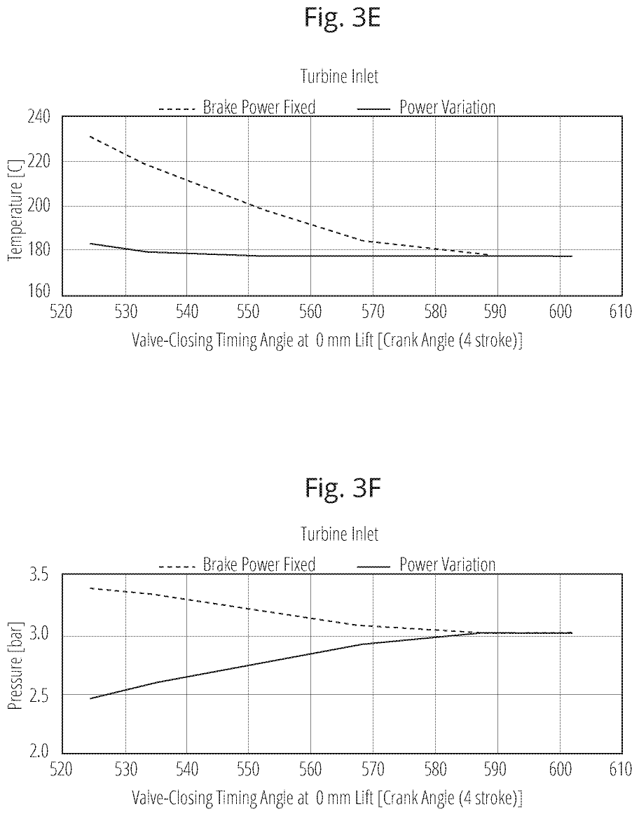

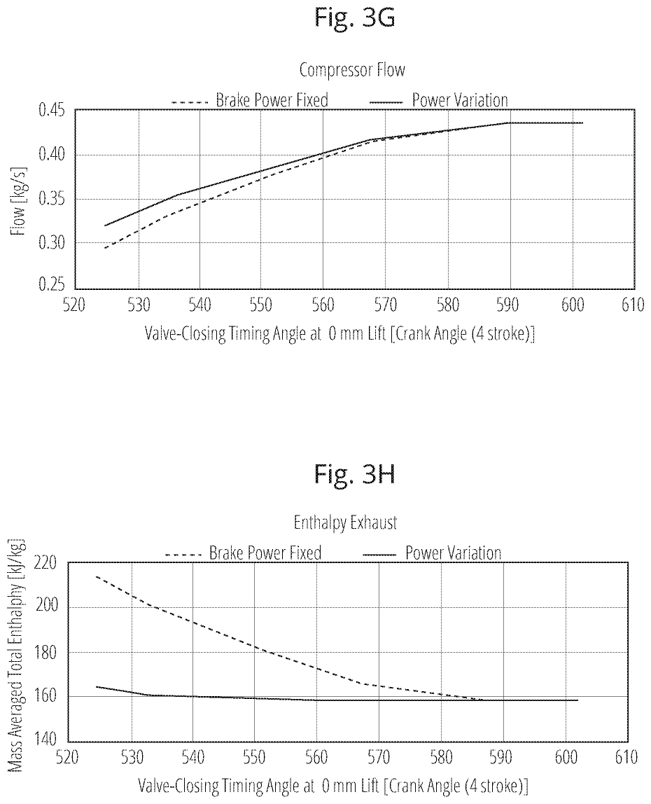

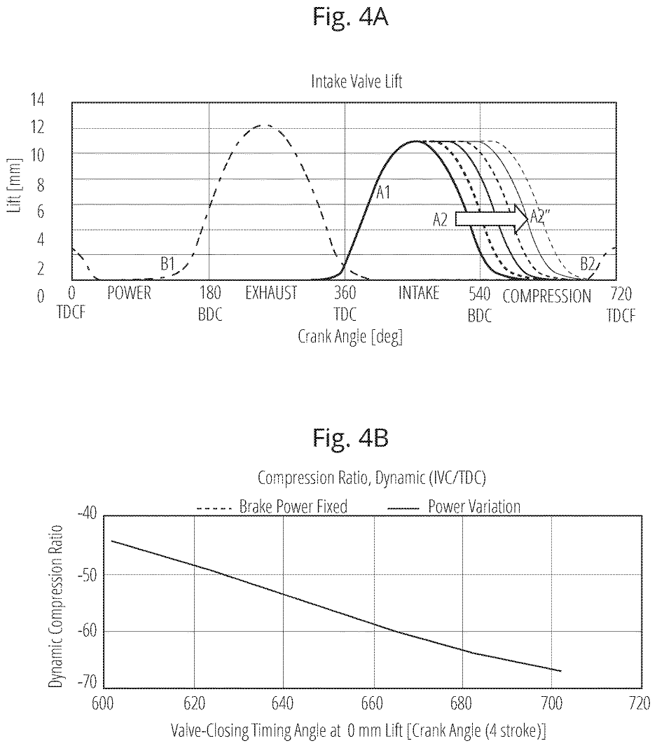

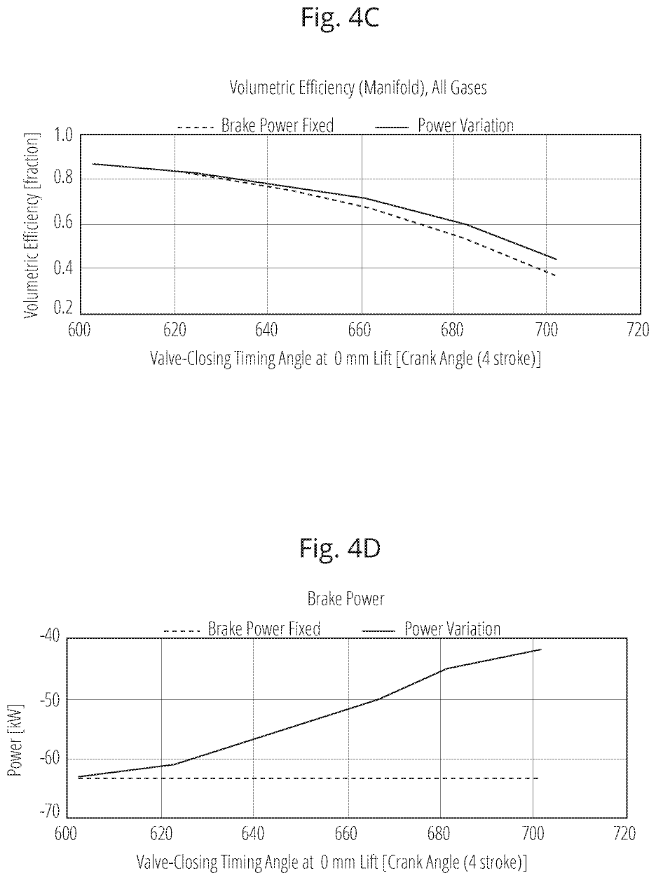

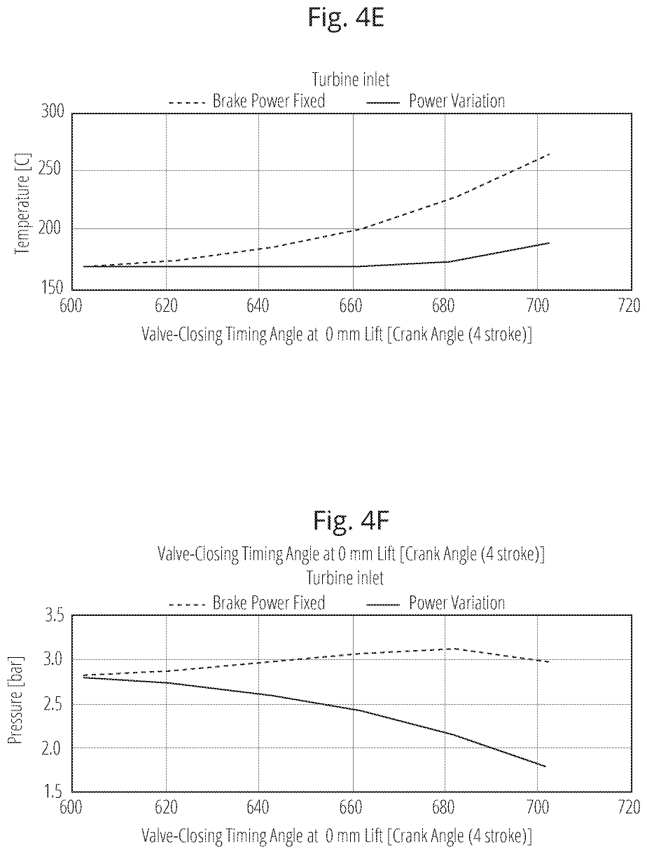

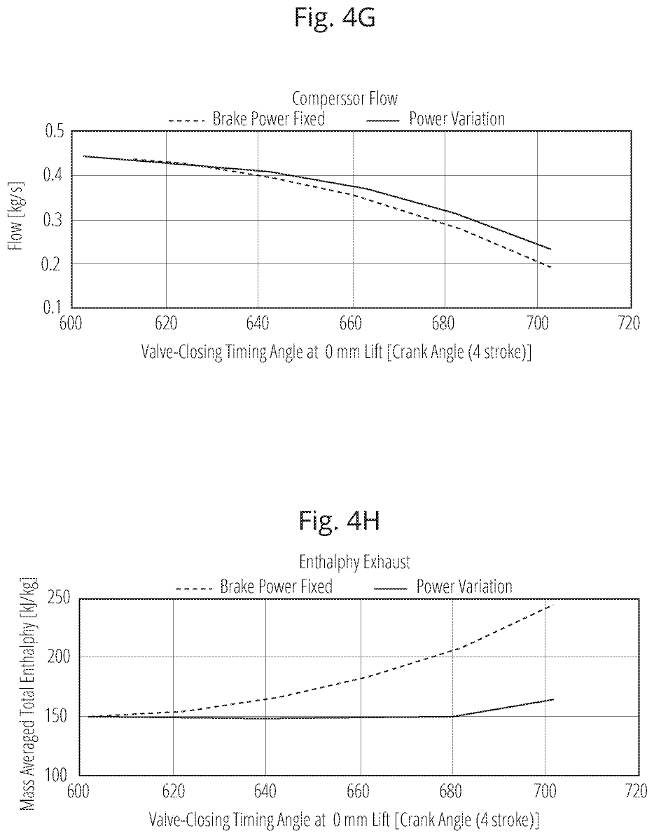

To further illustrate the various braking strategies FIGS. 3 and 4 show certain embodiments aspects of the invention. These diagrams collectively demonstrate how intake valve timing influences compression ratio, volumetric efficiency, brake power, turbine performance, and exhaust energy emphasizing the role of intake valve control in shaping braking torque and optimizing exhaust thermal properties; when keeping the exhaust valve in a standard engine braking mode, which is: briefly opening at the end of the compression stroke, but otherwise following a standard four stroke cycle.

As such these diagrams represent a systematic exploration of how intake and exhaust valve strategies affect in-cylinder pressure, brake power, and exhaust energy profile under various engine braking configurations.

FIGS. 3A-H illustrate examples of early intake valve closing (EIVC) timing, in which the intake valve is closed earlier in the intake stroke to similarly influence the dynamic compression ratio and exhaust gas enthalpy. Intake opening (A1), intake closing (A2) and exhaust valve opening and closing events (B1, B2) are shown across the four-stroke cycle under different engine braking scenarios. FIG. 3A represents a baseline or power-producing mode, wherein a closing event of the intake valve is shortened from A2 to A2′, for example, closing at a valve lift angle of about 520 degrees (4stroke) in a shortest variant A2′, and closing in a normal variant A2 at about 600 degrees. The Y axis indicates valve lift; the X-axis indicates actuation duration. The horizontal axis in each diagram represents crankshaft angle, ranging from bottom dead center (BDC) to top dead center (TDC) and back to BDC, completing the full four-stroke cycle: intake, compression, expansion, and exhaust. The intake valve 215 normally opens near TDC and closes after BDC, capturing the full intake stroke. In the engine braking scenario, exhaust valve 216 opens briefly (B2) near TDC at the end of the compression stroke, releasing compressed exhaust gases. The exhaust timing is a normal timing for engine brake operation, and illustrated for clarity reasons. For example, it is shown that the intake valve opens substantially shorter than the opening duration of the exhaust valve. While the invention is explained in the context of engine braking; also non-engine braking scenarios benefit from the valve lift adaptation. The red curve corresponds to a braking strategy where brake power remains fixed, while the blue curve represents a power variation mode, showing the impact of intake valve control on braking characteristics.

FIG. 3B depicts an engine braking mode with engine brake activation showing engine brake power values for each crank angle of the closing timing for the intake valve. Intake valve opening timing is unchanged. It is shown that the (negative) braking power increases for later angles of closing the intake valve during the intake stroke, which may be expected due to increased volumetric efficiency (see FIG. 3D). A scenario where brake power is kept fixed can be attained to increase the intake pressure, thereby increasing mass flow into the cylinder.

In the same scenario, FIG. 3C shows dynamic compression ratio for increasing (later) angles of intake valve closing, where at angles above BDC (540 in the Figure) the intake valve 215 remains open well into the compression stroke. This reduces effective compression and thus the brake torque.

FIG. 3D shows a volumetric efficiency wherein, with the intake valve 215 closing significantly earlier in the intake stroke the amount of trapped air mass decreases compression work and volumetric efficiency at lower crank angles.

FIG. 3E shows how the temperature increases at a fixed brake power and at early crank angles showing indeed that enthalpy can be enhanced by increased temperature at lower crank angles, with an increased volumetric efficiency. In cases where the intake pressure is not significantly adjusted, the temperature effects are less.

FIG. 3F similarly shows increased pressure at the turbine inlet when keeping the brake power fixed; but shows decreased pressure when the intake pressure is not adjusted, so that brake power will vary. The early closing of the intake valve 215 limits air charge, and the decompression event via exhaust valve 216 further reduces pressure build-up.

FIG. 3G displays a compressor flow being lowered for decreasing angles of closing the inlet valve aligning with FIG. 3D.

FIG. 3H displays an enthalpy increase for decreasing angles of closing the inlet valve, closely aligning with FIG. 3E.

FIGS. 4A through 4H illustrate the effect of late intake valve-closing timing (LIVC) on various performance parameters during engine braking. Here the intake valve is closed later (A2″) e.g. around 700 degrees (4-stroke) already in the compression stroke to reduce the dynamic compression ratio and control airflow through the engine during engine braking. Normal closing timing A2 is indicated to be around 600 degrees, similarly as in FIG. 3A. The horizontal axis in each diagram represents the valve-closing timing angle at 0 mm lift, measured in crank angle degrees for a four-stroke cycle.

FIG. 4A shows intake valve lift as a function of crank angle, highlighting variations in valve closing timing, with, in contrast with FIGS. 3A-3H are closed during the compression stroke, i.e. only a decreasing fraction of air remains trapped with increasing inlet closing angles. Different curves correspond to different intake valve closing angles, which influence the trapped air mass and the resulting dynamic compression ratio. FIG. 4B presents how the dynamic compression ratio changes with valve-closing timing. A later closing angle results in a lower dynamic compression ratio, directly affecting cylinder pressure and temperature.

FIG. 4C depicts volumetric efficiency, showing a decreasing trend as intake valve closing is delayed. This results from charge losses due to extended valve opening, which reduces the effective compression ratio. FIG. 4D illustrates brake power output under different valve timing strategies. In the power variation mode, brake power decreases as the valve closes later generating effectively less negative torque, whereas in the brake power fixed mode, it remains relatively stable.

FIG. 4E presents turbine inlet temperature as a function of valve closing timing. As the intake valve closes later, the temperature increases significantly in the brake power fixed mode, promoting greater heat transfer into the exhaust in similar ways as FIG. 3E. FIG. 4F shows turbine inlet pressure, where the brake power fixed mode maintains higher pressure compared to the power variation mode, which exhibits a decline with later valve closure similarly to FIG. 3F.

FIG. 4G displays the compressor flow rate, showing that mass flow decreases as intake valve closing is delayed similarly to FIG. 3G. This reduction in scavenging leads to higher retained pressures within the cylinder. FIG. 4H illustrates mass-averaged total exhaust enthalpy, which increases with later valve closing in the brake power fixed mode. This highlights the trade-off between braking power and exhaust enthalpy, with higher enthalpy values supporting improved aftertreatment system performance. The engine brake system may be part of an engine control system or may be a distinct control system. The ECU may comprise controlling software in order to set the engine braking mode. In particular, the ECU may be configured to regulate pressure in the various parts of the engine by controlling the values, in particular the VTG and the BPV, on the basis of the engine parameters such that a desired level of engine braking is achieved without exceeding predetermined system limits such as temperature, pressure and/or turbine speed. To that end, the ECU may receive information associated with various engine parameters. For example, the ECU may receive the exhaust manifold gas pressure measured by a exhaust manifold pressure sensor located in the exhaust manifold and the engine speed measured by an engine speed sensor. The ECU may further receive the air inlet gas pressure measured by an air inlet manifold pressure sensor, the ambient air pressure measured by a pressure sensor which is located external of the engine and/or a desired brake power demand.

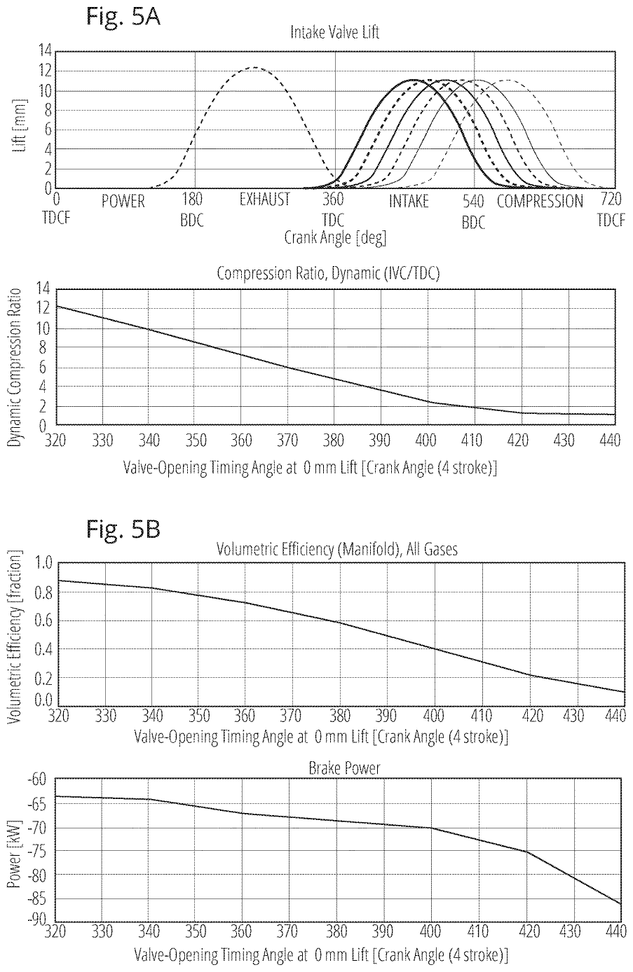

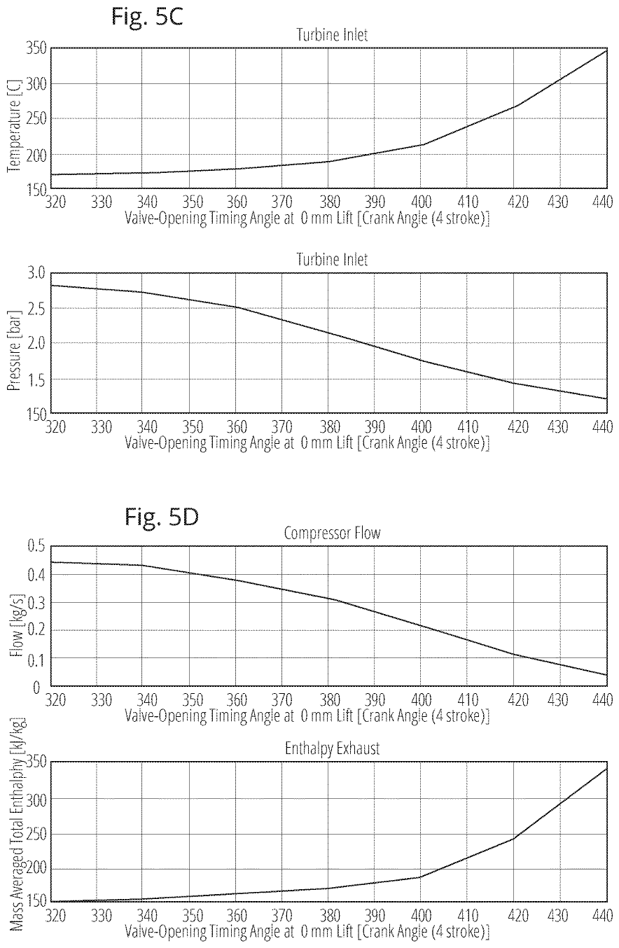

By way of contrast, FIG. 5A-D depicts a different controlling strategy that does not change phase duration, but the timing of the intake valve, which may be achieved by cam phase retarding. The valve follows an identical, but retarded cycle, without any phase duration change. It can be shown that this strategy is less favorable than the control mode explained above. In particular, in this control mode cam phasing limits the amount of air flow trapped in the cylinder during the intake stoke and keeps the intake valve opened (partly) during the compression stroke. This results in significant brake power deviations and resulting exhaust gas temperature. With this technology they cannot independently control the brake power w/o changing the exhaust gas temperature by varying the turbine inlet pressure.

For the present invention brake power can be regulated, for example, maintained at a brake target level and at the same time increase the exhaust gas temperature. Alternatively, exhaust gas temperature may be maintained and brake power can be changed. This control can be achieved by regulating the turbine inlet pressure. For the control method shown in FIG. 5 the trend is reversed: it can be seen that exhaust pressure P3 is lowered while brake power is increased and therefore they cannot independently regulate brake power and exhaust gas temperature.

1. An internal combustion engine comprising:
a plurality of cylinders, each having a reciprocating piston subject to an intake stroke, a compression stroke, an ignition stroke and an exhaust stroke; each of the cylinders having at least one intake valve, and at least one exhaust valve;
an intake system including an intake manifold fluidly connected to the intake valves of the plurality of cylinders for supplying intake air;
an exhaust system including an exhaust manifold fluidly connected to the exhaust valves of the plurality of cylinders for expelling exhaust gases;
an engine brake system operable to generate negative torque by adjusting the timing of at least one of the intake valves and the exhaust valves of the plurality of cylinders;
wherein the engine brake system comprises:
a control unit configured to change a duration of a phase wherein the intake valve is open to lower a dynamic compression ratio in a fraction of said plurality of cylinders during engine braking, thereby increasing the enthalpy of the exhaust gases relative to a given engine brake power output.

2. The internal combustion engine according to the preceding claim wherein a dynamic compression ratio is lowered by closing the intake valve of each cylinder in the fraction earlier in the intake stroke.

3. The internal combustion engine according to claim 1 wherein a dynamic compression ratio is lowered by closing the intake valve of each cylinder in the fraction later in the compression stroke.

4. The internal combustion engine according to claim 1 wherein a dynamic compression ratio is lowered by adjusting an intake valve lift of each cylinder in the fraction.

5. The internal combustion engine according to any preceding claim, wherein the fraction includes all of the plurality of cylinders, half of the plurality of cylinders and/or at least two of the plurality of cylinders.

6. The internal combustion engine according to any preceding claim wherein the control unit keeps an intake valve opening timing of the intake valves fixed during engine braking.

7. The internal combustion engine according to any preceding claim wherein the control unit keeps an intake valve valve lift of the intake valves fixed during engine braking.

8. The internal combustion engine according to any of the preceding claims, wherein the control unit is configured to regulate an intake pressure to control the engine brake power.

9. The internal combustion engine according to any preceding claims, wherein the control unit is configured to regulate an intake flow to control the engine brake power.

10. The internal combustion engine according to any preceding claims, wherein the control unit is configured to regulate the exhaust pressure to control the engine brake power.

11. The internal combustion engine according to any preceding claim, wherein the control unit is configured to increase an intake pressure while lowering the dynamic compression ratio in order to maintain a constant engine brake power and increase the enthalpy of the exhaust gases.

12. The internal combustion engine according to any preceding claim, further comprising an engine after treatment system.
